(19) United States
(12) Patent Application Publication
(10) Pub. No.: US 2025/0042310 A1
(43) Pub. Date: Feb. 6, 2025

(54) PRETENTIONER BELT FOR A VEHICLE SEAT BASE

(71) Applicant: GM Global Technology Operations LLC, Detroit, MI (US)

(72) Inventors: Prakash Venkatesh, Bangalore (IN); Vivekananda Kinila, Karnataka (IN); Rathan H. P., Karnataka (IN); Shiva Prakash LM, Bengaluru (IN)

(21) Appl. No.: 18/363,170

(22) Filed: Aug. 1, 2023

(51) Int. Cl. B60N 2/02; B60N 2/427

(52) U.S. Cl. CPC B60N 2/0276; B60N 2/42763

(57) ABSTRACT

A vehicle seat includes a seat base including a frame having a forward end a rearward end, a seat cushion supported by the frame, a flexible webbing member including a first end fixedly connected to one of the forward end and the rearward end and a second end supported at the other of the first end and the second end, and a tensioning device connected to the flexible webbing member at the second end. The tensioning device being selectively activated to adjust a tension in the flexible webbing member and reduce compressibility of the seat cushion.

### INTRODUCTION

The subject disclosure relates to the art of vehicle supplemental restraint systems and, more particularly, to a pretensioner belt arranged in a vehicle seat base.

Many passenger vehicles, particularly those manufactured after 1968, are equipped with passenger restraint systems. Initially, vehicles were equipped with lap belts. In some cases a separate shoulder belt may have been provided. The use of lap belts was shown to reduce deceleration injuries. As vehicle seating systems developed, improvements in restraint systems also came into being. A combined harness including a lap belt, a shoulder belt, and a retractor responsive to deceleration forces was developed and incorporated into vehicles. The combined harness further reduced deceleration injuries.

While effective at reducing injuries, crash forces are complex and out-of-position occupant excursions continue to exist. For example, forces may act on the occupant in a manner that exerts a compression force on a seat base. The compression force, coupled with forward movement, may cause the occupant's pelvis to slip under the lap belt or submarine. Such an out-of-position state results in undesirable force transfer to the occupant. Accordingly, there exists a need for an occupant restraint system that limits forward excursions of an occupant's pelvis.

### SUMMARY

A vehicle seat, in accordance with a non-limiting example, includes a seat base including a frame having a forward end a rearward end, a seat cushion supported by the frame, a flexible webbing member including a first end fixedly connected to one of the forward end and the rearward end and a second end supported at the other of the first end and the second end, and a tensioning device connected to the flexible webbing member at the second end. The tensioning device being selectively activated to adjust a tension in the flexible webbing member and reduce compressibility of the seat cushion.

In addition to one or more of the features described herein a webbing support mounted at the second end of the seat base, the first end of the flexible webbing member being fixedly connected to the forward end of the seat base and the second end of the webbing member passing through the webbing support.

In addition to one or more of the features described herein the seat cushion includes an upper surface and a lower surface, the flexible webbing member extending along the lower surface.

In addition to one or more of the features described herein the seat cushion includes an upper surface and a lower surface, the flexible webbing member extending along the upper surface.

In addition to one or more of the features described herein the seat cushion includes an upper surface and a lower surface, the flexible webbing member extending through the seat cushion between the lower surface and the upper surface.

In addition to one or more of the features described herein a tensioning device controller connected to the tensioning device, the tensioning device controller selectively tensioning the flexible webbing member to reduce compressibility of the seat cushion.

In addition to one or more of the features described herein a load limiting device coupled to the tensioning device, the load limiting device limiting an amount of tension imparted to the flexible webbing member by the tensioning device.

In addition to one or more of the features described herein the tensioning device includes one of a pretensioner, a pneumatic tensioner, an electric tensioner, and a hydraulic tensioner.

In addition to one or more of the features described herein a haptic alert system coupled to the tensioning device, the haptic alert system imparting rapid tension changes to the flexible web member.

A vehicle, in accordance with a non-limiting example, includes a body including a passenger compartment, and a seat arranged in the passenger compartment. The seat includes a seat base including a frame having a forward end a rearward end, a seat cushion supported by the frame, a flexible webbing member including a first end fixedly connected to one of the forward end and the rearward end and a second end supported at the other of the first end and the second end, and a tensioning device connected to the flexible webbing member at the second end, the tensioning device being selectively activated to adjust a tension in the flexible webbing member and reduce compressibility of the seat cushion.

In addition to one or more of the features described herein a webbing support mounted at the second end of the seat base, the first end of the flexible webbing member being fixedly connected to the forward end of the seat base and the second end of the webbing member passing through the webbing support.

In addition to one or more of the features described herein the seat cushion includes an upper surface and a lower surface, the flexible webbing member extending along the lower surface.

In addition to one or more of the features described herein the seat cushion includes an upper surface and a lower surface, the flexible webbing member extending along the upper surface.

In addition to one or more of the features described herein the seat cushion includes an upper surface and a lower surface, the flexible webbing member extending through the seat cushion between the lower surface and the upper surface.

In addition to one or more of the features described herein a tensioning device controller connected to the tensioning device, the tensioning device controller selectively tensioning the flexible webbing member to reduce compressibility of the seat cushion.

In addition to one or more of the features described herein a load limiting device coupled to the tensioning device, the load limiting device limiting an amount of tension imparted to the flexible webbing member by the tensioning device.

In addition to one or more of the features described herein the tensioning device includes one of a pretensioner, a pneumatic tensioner, an electric tensioner, and a hydraulic tensioner.

In addition to one or more of the features described herein a haptic alert system coupled to the tensioning device, the haptic alert system imparting rapid tension changes to the flexible web member.

A method of adjusting tension in a vehicle seat cushion, in accordance with a non-limiting example, includes detecting a driving condition, and tightening a flexible webbing member passing through a seat base to adjust a compressibility of a seat cushion.

In addition to one or more of the features described herein detecting the driving condition includes receiving feedback from a crash sensor.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a pretensioner arranged in a vehicle seat base, in accordance with a non-limiting example;

FIG. 2 is a cross-sectional side view of a vehicle seat including a seat base having a pretensioner belt, in accordance with a non-limiting example;

FIG. 3 is a cross-sectional front view of a vehicle seat including a pretensioner belt arranged between an upper surface and lower surface of a seat cushion, in accordance with a non-limiting example;

FIG. 4 is a cross-sectional front view of a vehicle seat including a pretensioner belt arranged on a lower surface of a seat cushion, in accordance with a non-limiting example;

FIG. 5 is a cross-sectional front view of a vehicle seat including a pretensioner belt arranged on an upper surface of a seat cushion, in accordance with a non-limiting example;

FIG. 6 is a top view of a pretensioner belt, in accordance with a non-limiting example;

FIG. 7 is a top view of a pretensioner belt, in accordance with another non-limiting example;

FIG. 8 is a top view of a pretensioner belt, in accordance with yet another non-limiting example; and

FIG. 9 is a block diagram illustrating a tensioning device controller associated with the pretensioner belt, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

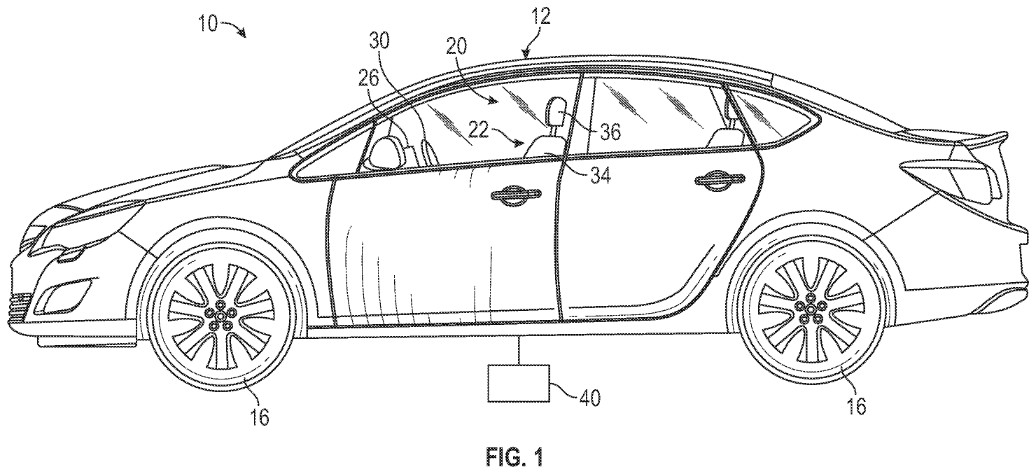

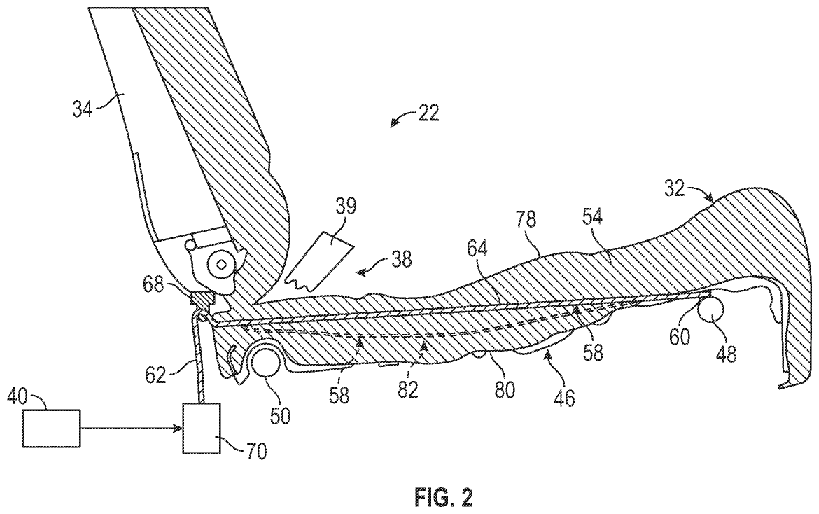

A vehicle, in accordance with a non-limiting example, is indicated generally at 10 in FIG. 1. Vehicle 10 includes a body 12 supported on a plurality of wheels 16. Body 12 includes a passenger compartment 20 within which are arranged a number of seats, such as indicated at 22. Seat 22 is positioned behind a dashboard 26. A steering wheel 30 is arranged between seat 22 and dashboard 26. Seat 22 includes a seat base 32, FIG. 2, and a seat back 34 supporting a head rest 36. A seat belt 38 including a lap belt portion 39, FIG. 2, extends across seat base 32 when an occupant is in seat 22. Seat belt 38 also includes a shoulder belt portion (not shown). A pretensioning device controller 40 is coupled to seat 22. As will be detailed herein, pretensioning device controller adjusts a compressibility of seat base 32.

Referring to FIG. 2, seat 22 includes a frame 46 having a forward end 48 and a rearward end 50. A seat cushion 54 is supported on frame 46. A flexible webbing member 58 runs across frame 46. That is, flexible webbing member 58 runs between forward end 48 and rearward end 50. Flexible webbing member 58 includes a first end 60, which in the non-limiting example shown, is fixedly connected to frame 46 at forward end 48. Flexible webbing member 58 also includes a second end 62 and an intermediate portion 64 extending between first end 60 and second end 62. Second end 62 passes over rearward end 50 through a webbing support 68. A tensioning device 70 is connected to second end 62. Tensioning device 70 is connected to tensioning device controller 40 and may take on a variety of forms including electrically operated tensioners, pneumatically operated tensioners, hydraulically actuated tensioners, as well as tensioners that may operate on expanding gases.

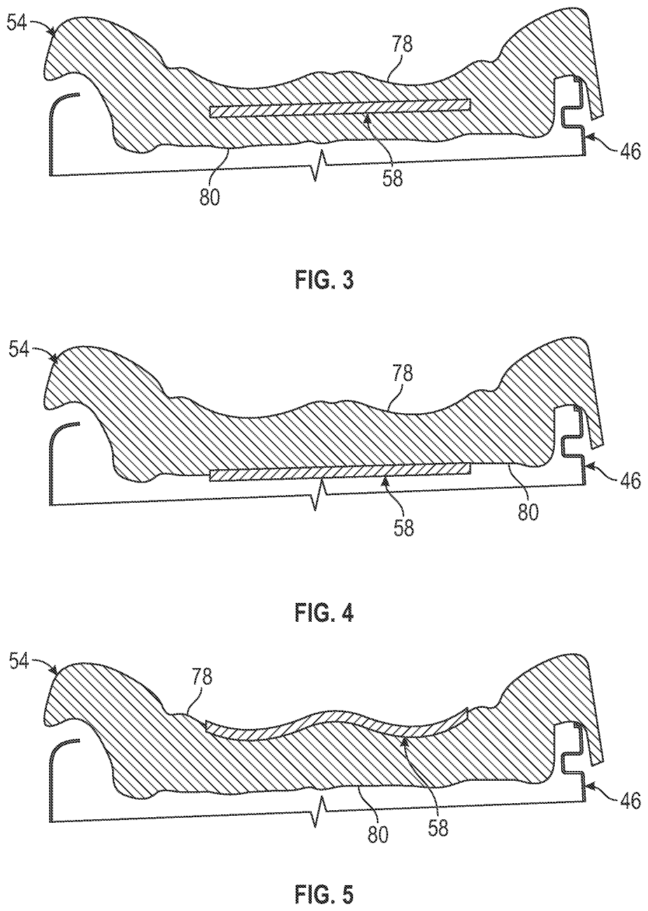

In a non-limiting example shown in FIG. 3 and with continued reference to FIG. 2, seat cushion 54 includes an upper surface 78 and a lower surface 80. Flexible webbing member 58 passes through seat cushion 54 between upper surface 78 and lower surface 80. In another non-limiting example shown in FIG. 4, flexible webbing member 58 runs along lower surface 80. FIG. 5 depicts flexible webbing member 58 running along upper surface 78 in accordance with another non-limiting example. As will be detailed more fully herein, during normal driving, flexible webbing member 58 in a relaxed configuration 82, FIG. 2, is imperceivable to the driver. However, during certain driving situations, such as a collision, in a non-limiting example, tensioning device 70 is actuated to adjust a compressibility of seat cushion 54 by pulling on second end 62 of flexible webbing member 58 to create tension. The tension in flexible webbing member 58 reduces compression caused by an occupant.

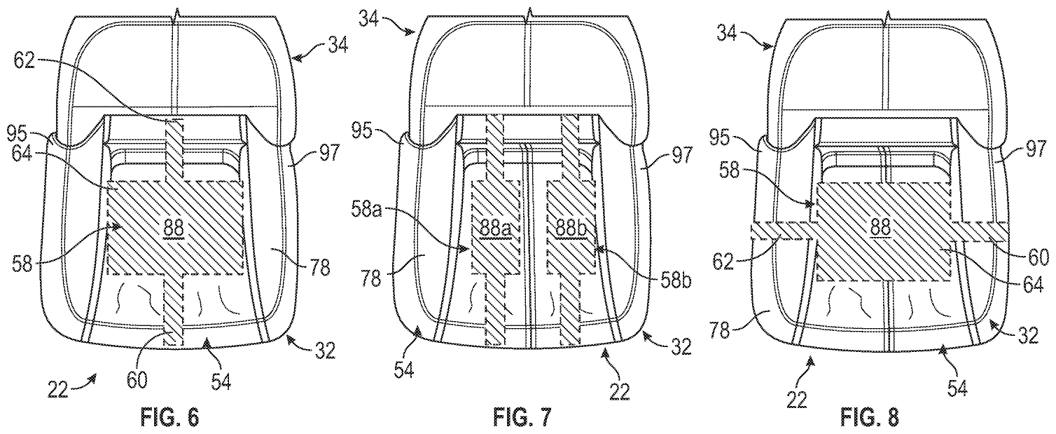

FIG. 6 depicts flexible webbing member 58 in accordance with a non-limiting example. Intermediate portion 64 includes a support zone 88 having a width that is greater than other portions of flexible webbing member 58. FIG. 7, depicts a first flexible webbing member 58a and a second flexible webbing member 58b extending from forward end 48 through rearward end 50. In a non-limiting example, first flexible webbing member 58a and second flexible webbing member 54b include a corresponding support zones 88a and 88b. In FIG. 8, flexible webbing member 58 is shown extending between a first side 95 and an opposing second side 97 of seat base 32. Regardless of orientation, pulling on second end 62 of flexible webbing member 58 will create tension that reduces compression caused by an occupant seated in seat 22.

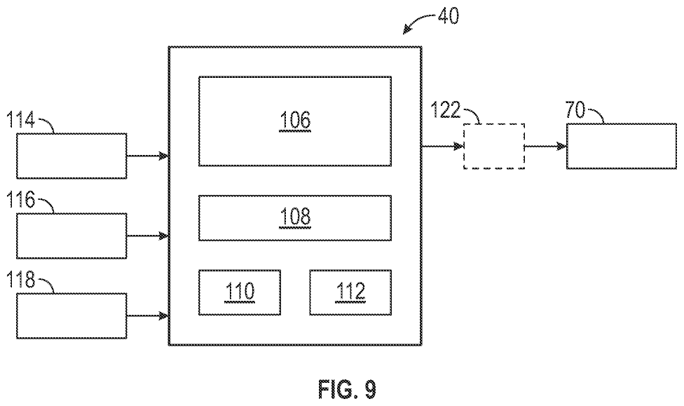

Reference will now follow to FIG. 9 in describing tensioning device controller 40 in accordance with a non-limiting example. Tensioning device controller 40 includes a central processing unit (CPU) 106, a memory module 108, an anti-submarine control module 110, and a haptic feedback control module 112. Tensioning device controller 40 is coupled to a first vehicle state sensor 114, a second vehicle state sensor 116, and a third vehicle state sensor 118. Vehicle sensors 114, 116, and 118 are arranged to detect various vehicle driving conditions including for example lane departures, impacts associated with collisions, as well as pre-collision sensing and the presence of passengers including a driver. For example, first vehicle state sensor 114 may take the form of a crash sensor, second vehicle state sensor may detect inconsistencies in driving accuracy such as lane departures and the like that may indicate the driver is tired, and third vehicle state sensor 118 may take the form of a seat occupancy sensor that detects a presence and weight of an occupant in seat 22.

In accordance with one non-limiting example, if a crash signal is received through first vehicle state sensor 114, anti-submarine control module 110 will activate tensioning device 70 to create tension in flexible webbing member 58. In a non-limiting example, anti-submarine control module 110 will activate tensioning device at an onset of a crash pulse. The tension in flexible webbing member 58 will limit how far an occupant may sink into seat cushion 54.

Anti-submarine control module 110 may rely on data stored in memory module 108, data received from seat occupancy sensor 120 to determine a load imparted on flexible webbing member 58 to create tension. In another non-limiting example, a load limiter 122 may be placed between tensioning device 70 and second end 62 of flexible webbing member 58. The tension created in flexible webbing member 58 by tensioning device 70 will limit seat sink or how far an occupant may sink into seat cushion 54 as a result of impact forces. By reducing occupant sink, substantially prevents or limits occupant hip excursions below lap belt portion 39 resulting in a submarine condition.

In accordance with another aspect of a non-limiting example, tensioning device 70 may operated in combination with haptic feedback control module 112 to provide inputs to a driver in seat 22. In a non-limiting example, if haptic feedback control module 112 receives a signal from second vehicle state sensor 116 indicating that the driver is exhibiting signs of being tired, tension device may be activated to impart rapid, low tension signals into seat cushion 54. The rapid, repeated low tension signals will inform a driver that it may be time to rest. If a continued signal is received from second vehicle state sensor 116, haptic feedback control module 112 may increase the duration and magnitude of the rapid, repeated low tension signals.

At this point it should be understood that the non-limiting examples presented herein describe a method and system for reducing submarining during a crash and also for providing haptic feedback to a driver. In the event of a crash, tension is applied to a flexible webbing member extending along or through a seat cushion. The tension reduces compressibility of the seat cushion thereby reducing a likelihood that an occupant may submarine below a lap belt. Tension may also be applied to the flexible webbing member in pulses in order to provide haptic feedback to a driver. During other times, the flexible webbing member is not perceivable by the seat occupant.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle seat comprising:
a seat base including a frame having a forward end a rearward end;
a seat cushion supported by the frame;
a flexible webbing member including a first end fixedly connected to one of the forward end and the rearward end and a second end supported at the other of the first end and the second end; and
a tensioning device connected to the flexible webbing member at the second end, the tensioning device being selectively activated to adjust a tension in the flexible webbing member and reduce compressibility of the seat cushion.

2. The vehicle seat according to claim 1, further comprising a webbing support mounted at the second end of the seat base, the first end of the flexible webbing member being fixedly connected to the forward end of the seat base and the second end of the flexible webbing member passing through the webbing support.

3. The vehicle seat according to claim 1, wherein the seat cushion includes an upper surface and a lower surface, the flexible webbing member extending along the lower surface.

4. The vehicle seat according to claim 1, wherein the seat cushion includes an upper surface and a lower surface, the flexible webbing member extending along the upper surface.

5. The vehicle seat according to claim 1, wherein the seat cushion includes an upper surface and a lower surface, the flexible webbing member extending through the seat cushion between the lower surface and the upper surface.

6. The vehicle seat according to claim 1, further comprising a tensioning device controller connected to the tensioning device, the tensioning device controller selectively tensioning the flexible webbing member to reduce compressibility of the seat cushion.

7. The vehicle seat according to claim 6, further comprising a load limiting device coupled to the tensioning device, the load limiting device limiting an amount of tension imparted to the flexible webbing member by the tensioning device.

8. The vehicle seat according to claim 1, wherein the tensioning device includes one of a pretensioner, a pneumatic tensioner, an electric tensioner, and a hydraulic tensioner.

9. The vehicle seat according to claim 1, further comprising a haptic alert system coupled to the tensioning device, the haptic alert system imparting rapid tension changes to the flexible webbing member.

10. A vehicle comprising:
a body including a passenger compartment; and
a seat arranged in the passenger compartment, the seat including a seat base including a frame having a forward end a rearward end;
a seat cushion supported by the frame;
a flexible webbing member including a first end fixedly connected to one of the forward end and the rearward end and a second end supported at the other of the first end and the second end; and
a tensioning device connected to the flexible webbing member at the second end, the tensioning device being selectively activated to adjust a tension in the flexible webbing member and reduce compressibility of the seat cushion.

11. The vehicle according to claim 10, further comprising a webbing support mounted at the second end of the seat base, the first end of the flexible webbing member being fixedly connected to the forward end of the seat base and the second end of the flexible webbing member passing through the webbing support.

12. The vehicle according to claim 10, wherein the seat cushion includes an upper surface and a lower surface, the flexible webbing member extending along the lower surface.

13. The vehicle according to claim 10, wherein the seat cushion includes an upper surface and a lower surface, the flexible webbing member extending along the upper surface.

14. The vehicle according to claim 10, wherein the seat cushion includes an upper surface and a lower surface, the flexible webbing member extending through the seat cushion between the lower surface and the upper surface.

15. The vehicle according to claim 10, further comprising a tensioning device controller connected to the tensioning device, the tensioning device controller selectively tensioning the flexible webbing member to reduce compressibility of the seat cushion.

16. The vehicle according to claim 15, further comprising a load limiting device coupled to the tensioning device, the load limiting device limiting an amount of tension imparted to the flexible webbing member by the tensioning device.

17. The vehicle according to claim 10, wherein the tensioning device includes one of a pretensioner, a pneumatic tensioner, an electric tensioner, and a hydraulic tensioner.

18. The vehicle according to claim 10, further comprising a haptic alert system coupled to the tensioning device, the haptic alert system imparting rapid tension changes to the flexible webbing member.

19. A method of adjusting tension in a vehicle seat cushion comprising:
detecting a driving condition; and
tightening a flexible webbing member passing through a seat base to adjust a compressibility of a seat cushion.

20. The method of claim 19, wherein detecting the driving condition includes receiving feedback from a crash sensor.
